(19) United States
(12) Patent Application Publication
(10) Pub. No.: US 2018/0322523 A1
(43) Pub. Date: Nov. 8, 2018

(54) RULES-BASED VOUCHER MANAGEMENT SYSTEM AND METHOD FOR PROCESSING SELF-SERVICE SUBSTANTIATION VOUCHER

(71) Applicant: Walmart Apollo, LLC, Bentonville, AR (US)

(72) Inventors: Eric Anthony Letson, Bentonville, AR (US); John Paul Thompson, Bentonville, AR (US); Emily McKenzie, Rogers, AR (US)

(21) Appl. No.: 15/971,022

(22) Filed: May 4, 2018

Related U.S. Application Data
(60) Provisional application No. 62/501,929, filed on May 5, 2017.

(51) Int. Cl. G06Q 30/02; G06Q 30/06; G06K 9/00

(52) U.S. Cl. CPC G06Q 30/0239; G06Q 30/0238; G06K 9/00671; G06Q 30/0643; G06Q 30/0603

(57) ABSTRACT

A system and method for voucher management comprise receiving and processing data including a rule regarding use of a voucher; generating a filtered result from the processed data; and modifying contents of a computer display output in response to the filtered result.

### RELATED APPLICATIONS

This application claims the benefit and priority of U.S. Patent Application No. 62/501,929, entitled “RULES-BASED VOUCHER MANAGEMENT SYSTEM AND METHOD FOR PROCESSING SELF-SERVICE SUBSTANTIATION VOUCHER,” filed on May 5, 2017, the contents of which are hereby incorporated by reference.

### TECHNICAL FIELD

The present inventive concepts relate generally to the use of substantiation vouchers, and more particularly to systems and methods for processing substantiation rules to control a display of e-commerce and/or in-store information.

### BACKGROUND

Online shopping offers a shopper the ability to browse a retail establishment's entire product offering from a computer. However, some retail establishments, in particular, e-commerce entities, may offer millions of items, requiring a complex search and filtering function.

Purchase substantiation generally refers to a purchase made by a customer, which is fully or partially paid for by a third party. For example, a provider may offer a gift card or other form of redemption voucher to a consumer to purchase certain items of interest. Purchase substantiation vouchers, in the form of shopping cards, gift certificates, coupons, or the like, may be used for online purchasing, for example, to redeem the value on the card, receive a discount, exchange points or other incentives, and so on. Here, the consumer enters transaction information to a displayed website, which in turn communicates the information to an e-commerce system, which processes data obtained from the voucher, and determines a value, balance, and/or discount with respect to items or services purchased at the website using the voucher.

For shoppers with substantiation vouchers having restrictions, it is difficult and time consuming to ensure that the voucher user is viewing and purchasing the items allowed under the restrictions.

### SUMMARY

In one aspect, provided is a method for voucher management comprising receiving and processing data including a rule regarding use of a voucher; generating a filtered result from the processed data; and modifying contents of an online location displayed on a computer display in response to the filtered result.

In another aspect, provided is a voucher management system, comprising: an input for receiving voucher data; a filter module for processing a use-based rule included in the voucher data and generating a filtered result; and a display modification module for modifying contents of an online location displayed on a computer display in response to the filtered result, including displaying items or services of interest identified by the filtered result.

In another aspect, provided is a method of redeeming a purchase voucher comprising: receiving a voucher identifier; retrieving voucher usage parameters associated with the voucher identifier; retrieving substantiation rules from the voucher usage parameters; and displaying one or more items for purchase permitted by the substantiation rules.

### BRIEF DESCRIPTION OF THE DRAWINGS

FIG. 1 is a network diagram of an environment in which embodiments of the present inventive concepts can be practiced.

FIG. 2 is a block diagram of a voucher management system, in accordance with some embodiments.

FIG. 3 is a flow diagram illustrating steps executable by elements of the environment of FIG. 1 for processing a self-service substantiation voucher, in accordance with some embodiments.

FIG. 4 is a flow diagram of a method for online shopping filtered by a substantiation voucher, in accordance with some embodiments.

FIG. 5 is a flow diagram of a method for online shopping at a micro-site, in accordance with some embodiments.

FIG. 6 is a flow diagram of a method for in-store augmented reality (AR) shopping, in accordance with some embodiments.

FIG. 7 is a flow diagram of a method for in-store shopping with substantiation vouchers, in accordance with some embodiments.

FIG. 8 is a view of a user interface display, including item information overlaid on a camera image, in accordance with some embodiments.

### DETAILED DESCRIPTION OF EMBODIMENTS

In brief overview, systems and methods are disclosed that provide self-service voucher processing, or more specifically, process user-defined restrictions assigned to a substantiation voucher to control the display of information regarding items and services authorized or prohibited according to the restrictions. Generally, a substantiation voucher can be used for any program in which a provider substantiates at least partially the purchase of goods and/or services by a consumer. The substantiation may be in the form of a payment to the retailer or other forms of compensation agreement with the retailer. The provider may be an individual or business entity authorized to set up the voucher for use by a consumer or other user. For example, the provider may use a computer to configure the voucher with data including but not limited to voucher type, balance, rebate, discount amount, and so on. In addition, the provider may assign a set of restrictions, or rules, regarding authorized merchandise and/or services. The provider may purchase the voucher as a gift card or the like and assign usage parameters, in particular, a set of restrictions or rules, to the voucher so that the person receiving the voucher can only use the balance or discount toward a specific filtered item or group of items. The voucher usage parameters are associated with a voucher identifier, which is used by a customer to redeem the purchase voucher with a retailer, and store the voucher usage parameters and the associated voucher identifier at a networked database.

In some embodiments where online purchases are made using a voucher, the displayed content from a website or other online e-commerce source is filtered according to the user-defined restrictions placed on the voucher. Here, a user of the voucher may be a shopper. The shopper may proactively impose the restriction on the voucher, or the shopper may be a receiver of the voucher from a controlling authority who imposes the restriction. For example, a parent of a college student may impose a restriction on a debit card that prevents the debit card from being used to purchase alcohol, or limits the debit card to purchase dorm room furniture only. When the debit card is used by the college student for online purchases at a store, any alcohol-related items are prevented from being displayed on the user interface of the computer display, or only furniture items are displayed. This is achieved by the system allowing the shopper to enter a “micro-site” or a filter mode on the website or software application where the only items displayed are a filtered result based on the rules of their vouchers. The voucher establishes and controls the display of item-related data for viewing by a user. In other embodiments, substantiation vouchers may be used during an in-store shopping experience, for example, an augmented reality (AR) shopping experience or other in-store shopping experience including the use of user mobile devices or other electronic computers.

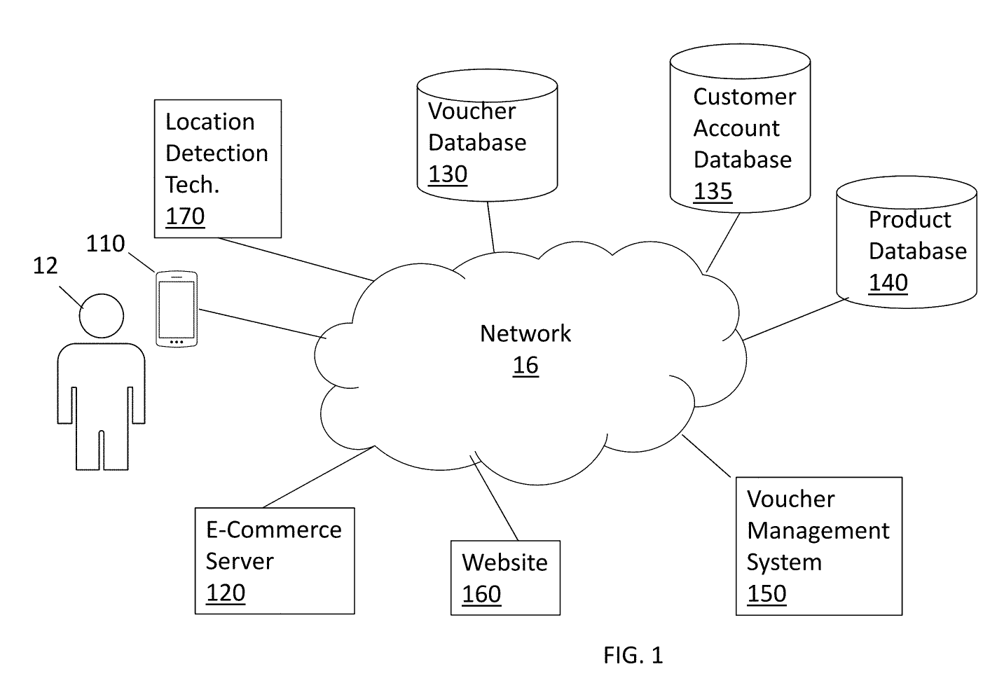

FIG. 1 is a network diagram of an environment in which embodiments of the present inventive concepts can be practiced. The retail environment comprises a user device 110, an e-commerce server 120, a voucher database 130, a customer account database 135, product database 140, voucher management system 150, and a website 160. Some or all of the components of the retail environment comprise a system and method for processing a self-service substantiation voucher, in accordance with some embodiments. The user device 110, e-commerce server 120, voucher database 130, customer account database 135, product database 140, voucher management system 150, and website 160 communicate with each other via an electronic communications network 16. In some embodiments, customer account database 135, product database 140, and website 160 are part of the e-commerce server 120, and more specifically, processes data stored therein. The network 16 may be a local area network (LAN), a wide area network (WAN), wireless network, and/or any other electronic communication exchange environment. In some embodiments, the network 16 includes elements of the Internet. In some embodiments, the network 16 includes a cloud computing system comprising hardware computers, network connectors, and/or other components well-known for processing and storing cloud computing data.

The user device 110 can be any processor-based device, for example, a mobile electronic device such a smartphone, electronic notepad, and so on, that directly or indirectly electrically accesses the e-commerce server 120, voucher database 130, customer account database 135, product database 140, voucher management system 150, and/or website 160. To perform a data exchange with the other components of the retail environment, the user device 110 includes a storage memory and one or more input and output devices such as a keyboard, touchscreen, display, and so on. In some embodiments where the user device 110 communicates electronically with other devices in an in-store shopping environment, the user device 110 includes an AR application, for example, Oculus Rift, Microsoft Hololens, etc., which may use location-based technology 170, a camera, or other elements of the device 110 to collect data regarding a location of the user 12, what items may be in view, or other data. In some embodiments, the location-based technology 170 communicates with other elements of the store environment via the network 16, which may include local area network such as WiFi and/or wide area network such as GPS or the like. The user device 110 is used by user 12, i.e., a purchaser, or person or entity seeking to redeem a voucher at a point of sale, for example, an in-store checkout terminal or an online store. The user 12 may be a recipient of a gift card, coupon, rebate offer, government assistance program, or other voucher-related benefit from which the substantiation voucher is based.

The voucher database 130 may store voucher information for voucher groups and individual vouchers, including voucher type and voucher usage parameters for each voucher as configured by the voucher creation interface. Vouchers may be generated by a voucher creation server, for example, described in international application no. PCT/US2015/042845 filed Jul. 30, 2016, entitled “Apparatus and Method for Self-Service Voucher Creation,” the contents of which are incorporated herein by reference in their entirety. A voucher may be a physical card on which is encoded a unique ID, which identifies other information stored on the remote voucher database 130, where a standard lookup (API, RESTful service call, etc.) can be made to the database 130 based on the unique card number

In some embodiments, the voucher database 130 stores provided-generated data, including usage parameters and voucher identifiers, and makes this accessible to the e-commerce server 120 or other point of sale system and the voucher management system 150. The database 130 may further store voucher redemption status information and/or voucher balance information for each voucher identifier in the system. The point of sale system, e.g., e-commerce server 120, may accept a voucher identifier shown on the user device 110. In some embodiments, each voucher has a unique voucher identifier and is intended to be used by a single customer. In some embodiments, each voucher identifier can only be redeemed once. In some embodiments, the voucher identifier can be used as long as there is a positive balance on the voucher or before an expiration date. In some embodiments, the voucher identifier may be generated for distribution to multiple customers. For example, a voucher can include a coupon code for certain products that any customer can use. In the abovementioned embodiments, the voucher management system 150 includes a voucher tracking processor 250 that collects status data regarding a voucher, for example, to ensure that the voucher is used once, used when there is a positive balance, and so on. An in-store point of sale system may include a scanner, a card reader, a keypad etc. for entering the voucher identifier. For an online point of sale, a customer may enter a voucher code and/or pin code, or click through a link provided with the voucher to apply the voucher to an online purchase. The point of sale system may forward the voucher identifier to the voucher management system 150 to determine the voucher usage parameter associated with a received voucher identifier. The voucher management system 150 facilitates the redemption of a purchase voucher based on the information stored on the voucher database 130, account database 135, product database 140, or a combination thereof. The voucher management system 150 may retrieve information associated with a voucher identifier.

The product database 140 may store information on products that may be purchased at a point of sale system (not shown), for example, online store presenting website 160. Products may include physical items, gift cards, and/or services, etc. The product database 140 may store information on one or more of product category, product type, manufacturer, nutritional value, maturity rating, and price etc. The products may be grouped by one of more of their attributes. Each group may also contain one or more levels of subgroups. In some embodiments, the product database 140 also stores product groups specified by retailers, manufacturer, and/or users. For example, the product database 140 may store a list of items selected by a user through the self-service voucher creation interface and make that list available for selection by other users creating their own vouchers. The product database 140 provides product information to the voucher creation interface such that a user can browse and/or search through products, product groups, and/or product sub-groups to generate a list of authorized or unauthorized products for the voucher being created. The voucher management system 150 communicates with at least the voucher database 130 and product database 140 to provide information to the user interface on the user device 110 and/or e-commerce server 120 which in turn determines the content displayed at the website 160.

The website 160 in communication with the e-commerce server 120 is constructed and arranged to promote and sell products globally, for example, by performing operations executed on a computer server in the Internet network. Although a website 160 is described, any online location connected to the Internet that maintains one or more pages on the World Wide Web or other public or private network may equally apply. The e-commerce server 120 may include at least one database to support marketing, sales, customer support, and accounting functions, but is not limited thereto. The website 160 when displayed at the user device 110 may permit a user 12 to view goods such as store products, services, or other items for sale by processing and displaying information received from the e-commerce server 120, for example, information on presented items stored at the product database 140. The e-commerce server 120 may include subsystems for performing order fulfillment, pricing, payment processing, promotions, security, shipping, electronic shopping carts, and so on. The website 160 may execute a shopping cart application to provide a virtual store in which the user 12 may view item information (from data retrieved from the product database 140), add and delete items for purchase, change item quantities, and so on.

The customer account database 135 stores information relating to customers, such as user 12. When customer selections are made, the e-commerce server 120 may communicate with the customer account database 135 to retrieve and process log-in credentials, billing information (i.e., name, address, and credit card number) or the like and to confirm the transaction.

The voucher management system 150 processes substantiation rules to control an online display of e-commerce information. For example, the voucher management system 150 is constructed and arranged to filter website content for display according to the user-defined restrictions placed on substantiation vouchers so that a user of a voucher can only view restricted content, and cannot view content prohibited under the restrictions. The voucher management system 150 may include a voucher redemption feature, or be part of a voucher redemption server that facilitates a redemption of a purchase voucher based on the information stored at the voucher database 130, for example, described in international application no. PCT/US2015/042845 incorporated by reference herein.

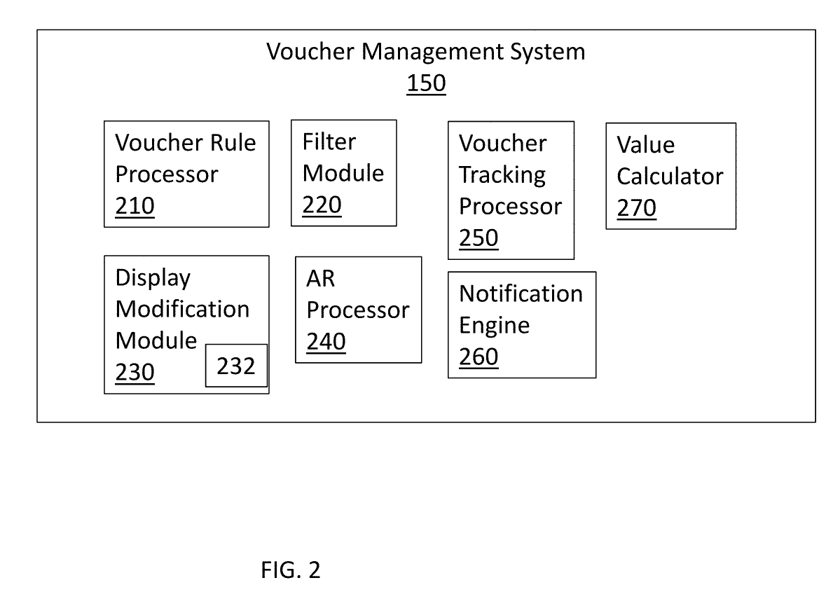

As shown in FIG. 2, the voucher management system 150 in some embodiments comprises a voucher rule processor 210, a filter module 220, a display modification module 230, an AR processor 240, a voucher tracking processor 250, a notification engine 260, and a value calculator 270. Some or all of the voucher rule processor 210, filter module 220, display modification module 230, AR processor 240, voucher tracking processor 250, notification engine 260, and value calculator 270 may be part of a same computer platform, or at separate processor devices that communicate with each other via the network 16.

The voucher rule processor 210 receives and processes data including usage parameter restrictions regarding voucher use. The voucher rule processor 210 may receive a voucher identifier from the e-commerce system 120, and uses the voucher identifier to retrieve voucher usage parameters associated with a received voucher identifier. The voucher rule processor 210 is configured to compare a received substantiation voucher rule and a rule database, for example, part of the voucher database 130, to identify rules for submitted vouchers.

The filter module 220 processes use-based rules included in the received voucher data, and generates a filtered result.

The display modification module 230 modifies contents of a website according to the filtered result, including displaying items or services of interest identified by the filtered result. In some embodiments, the display modification module 230 includes a micro-site widget interface 232 that communicates with the e-commerce server 120 to seamlessly transfer the user 12 to a micro-site widget or filter mode where only items displayed are a filtered result based on the rules of the substantiation vouchers. A filter mode refers to the website 160, where a display of content is controlled, for example, where the voucher data is processed by the e-commerce server 120 to display content pertinent to the voucher. Once the user 12 logs into the system and selects one or more vouchers to use, a list of departments/categories and the items displayed on the website are filtered to display and permit access to only those allowed according to substantiation rules established for the voucher. A micro-site on the other hand, is a location other than the website 160, where the e-commerce server 120 controls the display of the other location, or micro-site, according to the voucher. A micro-site widget operates in a similar manner as the main website 160 but includes additional functionality regarding item or service discounts or the like. The micro-site widget interface 232 can combine a normal item detail page with information typically found in an online shopping cart. For example, the e-commerce server 120 can reset a webpage to selectively allow the user 12 to purchase items in an online shopping cart based on a particular voucher. In addition to item details, a micro-site widget of the website 160 in addition to item details can include a price after voucher-based discount and how much of the voucher was used, or balance remaining on the voucher. As the user 12 adds items to their cart, the voucher balance being displayed is recalculated. For example, this may include a list of store departments in a dropdown screen at the website 160, the results of an item search, and any item pages used as home pages, a main website homepage, a department homepage, an item homepage, and so on.

The AR processor 240 receives and processes context data that includes real-time data, for example, provided by a location technology device 170. The context data preferably includes information about the current location of the user 12, a location of items of interest or items available for purchase according to the voucher, and information about the items, which are required at a minimum to provide the user 12 with an adequate AR shopping experience. Related other context data may include information about how to identify items, which include item images, barcodes, watermarks, shelf label, etc. The context data may be applied to a use restriction, such as a rule established for a voucher. The filter module 220 can generate a filtered result from a combination of the context data and the processed data.

The notification engine 260 may communicate with the e-commerce server 120 to alert the user 12 via the user device 110, for example, displaying alerts on the website 160 executed at the user device 110, when a voucher added to the customer account is about to expire, when a voucher is about to expire on items discounted by vouchers in an abandoned online cart, when adding an item to a cart where the discount no longer matches the original discount they were shown after applying a hold against the voucher, and so on. For example, the price and/or discount amount of an item of interest permitted for purchase under voucher may change between a time from when the item is added to an online cart and the time that the purchase is completed. In this example, due to the price increase, there may be an insufficient balance on the voucher to cover the purchase. Here, an alert may be generated to notify the user 12 of this price change and/or an insufficient balance on the voucher.

The value calculator 270 is constructed and arranged to generate a result of applying one or more substantiation vouchers to items purchased. Multiple calculations may be performed to determine different savings or discount options for the user 12. Here, the value calculator 270 can compare the different options and generate a result that includes the best option, i.e., the greatest discount and so on.

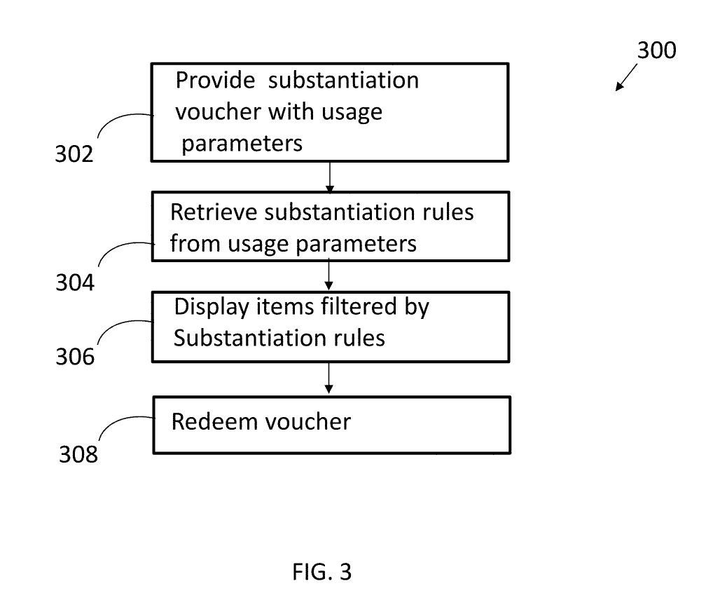

FIG. 3 is a flow diagram illustrating steps of a method 300 executable by elements of the environment of FIG. 1 for processing a self-service substantiation voucher, in accordance with some embodiments. In describing the method 300, reference is made to elements described with respect to FIGS. 1 and 2.

At block 302, a substantiation voucher is provided that includes usage parameters. A provider may wish to include or exclude certain products that are redeemable with their voucher, and pre-load the voucher with usage parameters along with other data such as a fixed amount of value, a replenishment value, a balance, point value, or other currency-related information that may be exchanged for items or services of interest. An example of a usage parameter may include a government assistance program that wishes to exclude alcohol and high price electronics from being purchased with their vouchers. In another example, a parent may wish to send their child on a shopping trip with a gift card that can only buy back-to-school items. In yet another example, a friend may wish to give a gift card to a new mother that can only be used to purchase baby care-related products. When a provider sets up a voucher, he/she can select one or more products to either include or exclude from the usage of the created voucher. If the provider chooses to set inclusion rules, the voucher will only be authorized to be applied to the included product. If the provider chooses to set exclusion rules, the voucher can be used to purchase any non-excluded product.

At block 304, substantiation rules are retrieved from usage parameters of one or more substantiation vouchers by the voucher management system 150. The substantiation rules may include inclusion rules, where the voucher is authorized to be applied to identified products or services, or exclusion rules, where identified products are excluded, and the voucher is authorized to be applied to non-excluded products or services.

At block 306, the online store of the website 160, in-store checkout terminal, or other point of sale display shows only items filtered by the substantiation rules.

At block 308, the user 12 shops for the filtered set of items, and after identifying a filtered item of interest, can redeem the voucher. In doing so, the user 12 selects the voucher or vouchers to be used for purchasing the items of interest. When redeeming the voucher, a voucher identifier is received at the point of sale. In some embodiments, the e-commerce server 120 accepts a voucher identifier shown on a mobile device. For an online point of sale, the user 12 may enter a voucher code and/or pin code, or click through a link provided with the voucher to apply the voucher to an online purchase. One or more items identified may also be scanned or added to a virtual shopping cart at the point of sale. The usage parameters associated with the received voucher identifier are retrieved. The point of sale system 160 may forward the voucher identifier to the voucher redemption server 150 to determine the voucher usage parameter associated with a received voucher identifier. The voucher redemption server 150 facilitates the redemption of a purchase voucher based on the information stored on the voucher database.

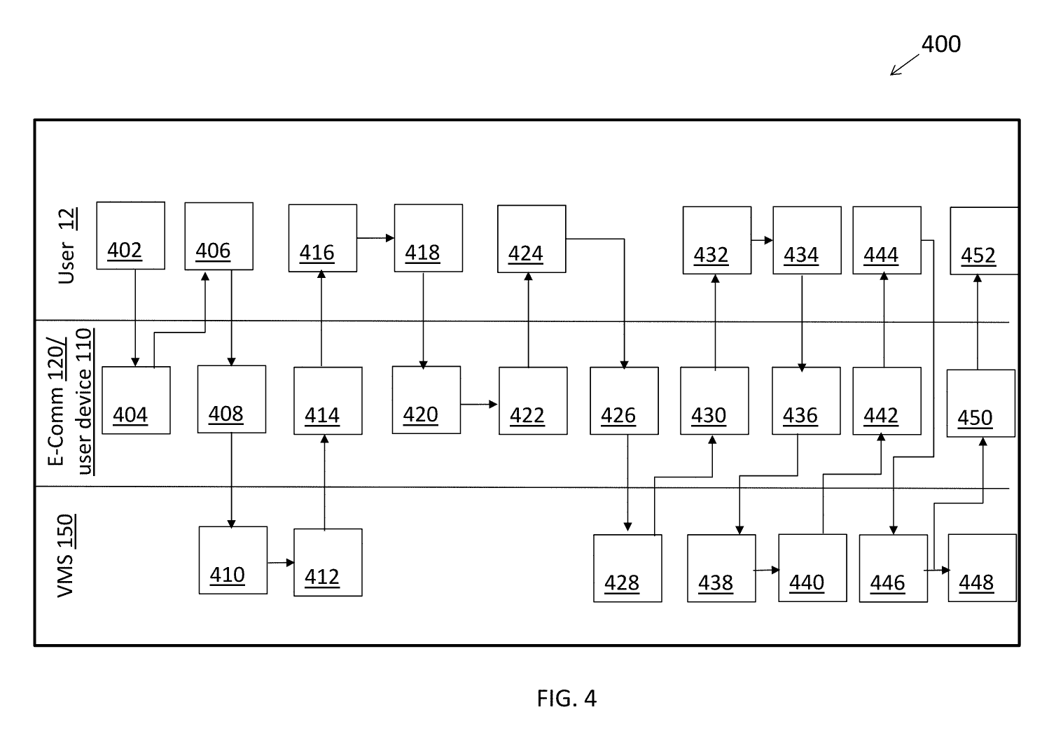

FIG. 4 is a flow diagram of a method 400 for online shopping filtered by a substantiation voucher, in accordance with some embodiments. Steps of the method 400 may be executable by one or more of the computer elements described in the environment illustrated in FIG. 1.

At block 402, a user 12 receives a substantiation voucher. The voucher can be at least one of a shopping card, gift card, a government benefits card (WIC/EBT), royalty benefits card, reusable card, single-use card or coupon that is physical or digitally presented for use. The physical configuration of the voucher may include a magnetic stripe, bar code, QR code, embossed/printed card number, or embossed/printed security pin to use for identification. The substantiation voucher may include a unique identification that corresponds to voucher-related data such as but not limited to voucher type, balance, rebate, discount amount, and usage parameters, which may be stored at the voucher database 130 and/or voucher management system 150. The voucher identification may be stored on a magnetic stripe, barcode, QR code, RFID chip, embossed or printed card number, embossed or printed security pin, and so on used for identification.

At block 404, the substantiation voucher is added to the user account stored at the customer account database 135. This may be performed either by a website 160 of the e-commerce server 120 or at a software application executed at the user device 110 that communicates with the e-commerce server 120. In some embodiments, the voucher may be linked to a provider billing account or replenishable account. In some embodiments, the provider may pre-load the voucher with a fixed amount for one-time use. In some embodiments, the provider may pay for the balance on the voucher after it has been redeemed. In some embodiments, the voucher may be replenished on a periodic basis by the provider. When linked in this manner, when the voucher is redeemed, the retailer would either notify the provider to provide the rebate or may be authorized to provide the rebate to the user 12 at the point of sale. Points may be added based on item count or monetary amount spent. An item, a monetary amount, or a discount amount may be added to the voucher for redemption when a certain number of points have been accumulated.

At block 406, the user 12 selects one or more vouchers to shop with. The user device 110 may display a list of voucher types for the user 12 to select. An administrator or other authorized user may create the voucher, for example, according to a technique described in international application no. PCT/US2015/042845 filed Jul. 30, 2016, the contents of which are incorporated by reference above, whereby the voucher data is stored at the database 130 and/or voucher management system 150 for subsequent retrieval.

At block 408, substantiation rules corresponding to the selected voucher(s) are retrieved by the voucher management system 150. For example, the substantiation rules may be stored at the voucher database 130 and/or voucher management system 150. In some embodiments, a rule may correspond to multiple vouchers.

At block 410, the voucher management system 150 searches for, finds, and validates the substantiation vouchers selected at block 406. During validation, a determination is made that the voucher exists, is active, authorized, and has value available for use. Valid vouchers may be stored at the voucher database 130.

At block 412, the voucher management system 150 processes the rules for each identified and validated substantiation voucher. In response, at block 414, a micro-site widget or filter mode of a website displays only items filtered by the substantiation rule, for example, inclusion and/or exclusion rules.

At block 416, the user 12 can shop online for the filtered items, for example, from website 160. The user 12 cannot shop for items filtered according to the substantiation rule, since information about those items is not displayed or otherwise accessible to the user operating under the selected voucher. The e-commerce server 120 may receive instructions or other control signals from the voucher management system 150 to establish the conditions under which the website display is generated and presented.

At block 418, the user 12 identifies an item of interest. In embodiments, where the user 12 can avail of multiple vouchers, the user may select a voucher that may be used to purchase the item of interest. The e-commerce server 120 and/or voucher management system 150 may retrieve from the voucher database 130 relevant voucher data such as voucher ID, voucher balance, authorized merchandise and service, and so on.

At block 420, the e-commerce server 120 recalculates a remaining amount on vouchers being used by checking the rules of substantiation. As items are added by the user 12 to the shopping cart, the voucher balance is recalculated. If the user 12 exceeds the spending amount on the voucher, the website 160 may display an alert, a remaining voucher balance, and/or other relevant information. If the user 12 continues to search for items, the original price applies, since there is no longer a balance on the selected voucher.

At block 422, the user interface of the user device 110 displays a result, for example, including price, discount, voucher balance, and/or other information determined by the rules. For example, the price displayed includes the results of applying the substantiation voucher resulting in a discounted or $0 purchase price.

At block 424, the user 12 decides to purchase the item of which information is displayed at block 422. In doing so, the purchased item may be added to an electronic shopping cart.

At block 426, to ensure that the voucher is used properly, the website 160 or mobile application may apply a “hold” value against the voucher for the amount of the item added to the electronic shopping cart as the user 12 adds items to the cart. This feature prevents a separate instance of the website 160 or mobile application from being used to also get a discount. The value on hold cannot be applied to items in the additional shopping instance until they are removed from the shopping cart tied to the first instance of shopping. Another method would not perform an item-by-item hold and would only put a hold against the voucher during the checkout process. If the shopper abandons the checkout process, any hold on the voucher or other payment source is released.

At block 428, a remaining value on the voucher is verified and updated with any hold amount.

At block 430, the item added to the cart in block 424 is modified to include additional voucher data, which is likewise added to the cart. An alert may be generated for any changes that may occur with respect to price, item availability, or other events that may affect the voucher status.

At block 432, a checkout process is initiated by the e-commerce server. As part of the checkout process, at block 434, the user 12 may view the shopping cart displayed at the website 160, which may include a display of voucher-based discounts for each item, which provides the user 12 an opportunity to view and confirm the information displayed at the checkout.

At block 436, the e-commerce server 120 requests a discount for the items in the shopping cart. At block 438, the voucher management system 150 validates the items in the shopping cart and the discount information with the selected voucher(s). In some embodiments, the voucher management system 150 places a “hold” value on the voucher if not previously performed.

At block 440, the voucher management system 150 provides a result of applying the substantiation voucher(s) to items purchased. At block 442, the e-commerce server 120 provides an updated total after applying the substantiation vouchers. The e-commerce server 120 may include an application programming interface (API) for communicating with the voucher management system 150. During a checkout process, a final validation step may be performed, whereby the e-commerce server 120 is updated. For example, a total of $20 in purchases is made. The e-commerce server 120 in this example performs a checkout process to render payment of the purchased items prior to accessing the voucher and its conditions.

At block 444, the user 12 at the website 160 completes the checkout process. In doing so, the user 12 may view how much remains on the voucher(s) used to perform the purchase.

At block 446, the voucher management system 150 updates the substantiation voucher with revised information, such as usage, balance with purchase, and so on.

At block 448, the voucher management system 150, in particular, the notification engine 260, notifies the issuer of usage by accessing the provider account, payment data database of the e-commerce server 120, customer account database 135, or a combination thereof.

At block 450, the e-commerce server 120 prepares the order for fulfillment. At block 452, the user 12 is notified that the order has been placed.

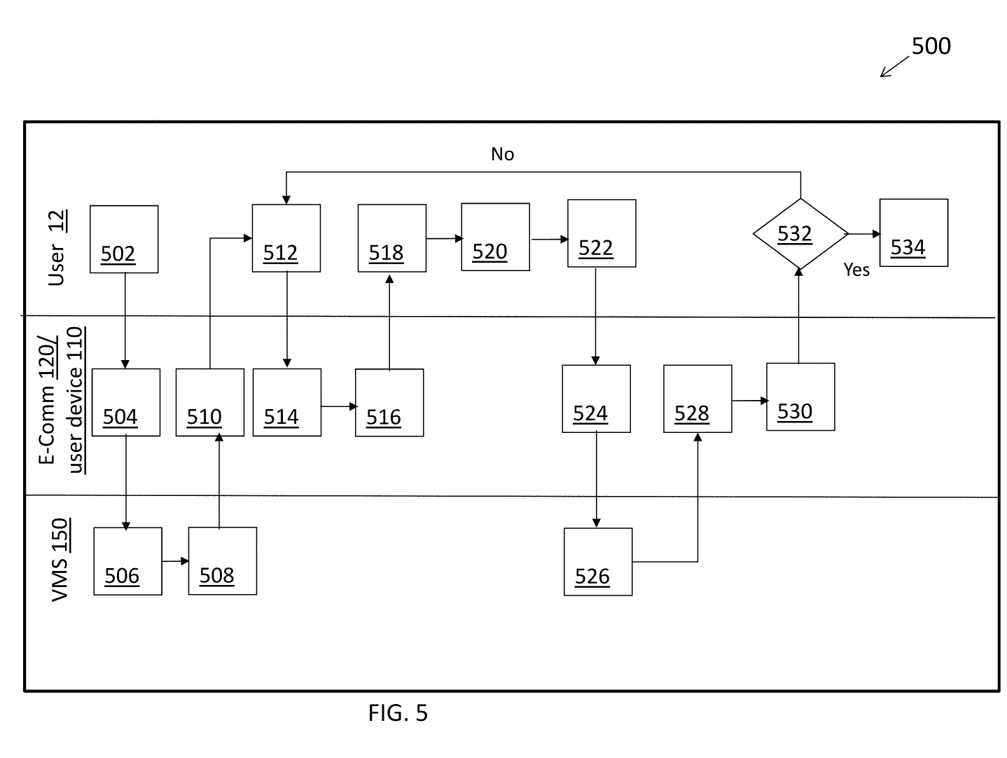

FIG. 5 is a flow diagram of a method 500 for online shopping at a micro-site in accordance with other embodiments. Steps of the method 500 may be executable by one or more of the computer elements described in the environment illustrated in FIG. 1.

At block 502, the user 12 chooses one or more vouchers to shop with. Block 502 is similar to block 406 of method 400 described in FIG. 4, and therefore details are not repeated due to brevity.

At block 504, substantiation rules corresponding to the selected voucher(s) are retrieved by the voucher management system 150, for example, stored at the customer account database 135 or the voucher database.

At block 506, the voucher management system 150 searches for, finds, and validates the substantiation vouchers selected at block 502.

At block 508, the voucher management system 150 provides rules for each submitted substantiation voucher. Block 508 is similar to block 412 of method 400 described in FIG. 4, and therefore details are not repeated due to brevity.

At block 510, the website 160 of the e-commerce server 120 or software application executed at the user device 110 that communicates with the e-commerce server 120 transfers the user 12 to a micro-site or mode on the website 160 or software application where the only items displayed are a filtered result based on the rules of the user's voucher.

At block 512, the user 12 searches for an item or service of interest under the confines of the micro-site, filter, or website mode.

At block 514, the e-commerce server 120 generates an item page displayed at the website 160 or software application executed at the user device 110 corresponding to the searched item or service of interest.

At block 516, the user interface of the user device 110 displays a result, for example, including price, discount, voucher balance, and/or other information determined by the rules. Thus, the user 12 may view voucher data such as current balance, price discounts, and/or other information that may be useful in informing the user 12 with respect to purchase decisions. For example, the price displayed includes the results of applying the substantiation voucher resulting in a discounted or $0 purchase price. A micro-site, when displayed, may provide the foregoing voucher information and/or additional information for the user with respect to the voucher.

At block 518, the user 12 decides to purchase the item of which information is displayed at block 516. At block 520, vouchers used to purchase the item can be selected. At block 522, the user 12 item of interest may be added to an electronic shopping cart.

At block 524, to ensure that the voucher is used properly, the website 160 or mobile application may apply a “hold” value against the voucher for the amount of the item added to the electronic shopping cart as the user 12 adds items, or more specifically, data pertaining to selected items, to the electronic shopping cart, where such data is processed by a computer processor and stored in a data memory. This feature prevents a separate instance of the website 160 or mobile application from being used to also get a discount. The value on hold cannot be applied to items in the additional shopping instance until they are removed from the shopping cart tied to the first instance of shopping. Another method would not perform an item-by-item hold and would only put a hold against the voucher during the checkout process. If the shopper abandons the checkout process, any hold is released. At block 526, a remaining value on the voucher is verified and updated with the hold amount. At block 528, the item is added to the cart with applicable vouchers. At block 530, the user 12 receives a notification such as an alert if the voucher limit has been reached.

At decision diamond 532, a determination is made whether the user 12 has completed shopping. If yes, then the method 500 proceeds to block 534 where a checkout process is performed. Otherwise, the method 500 proceeds to block 512, where the user 12 continues to search for items of interest.

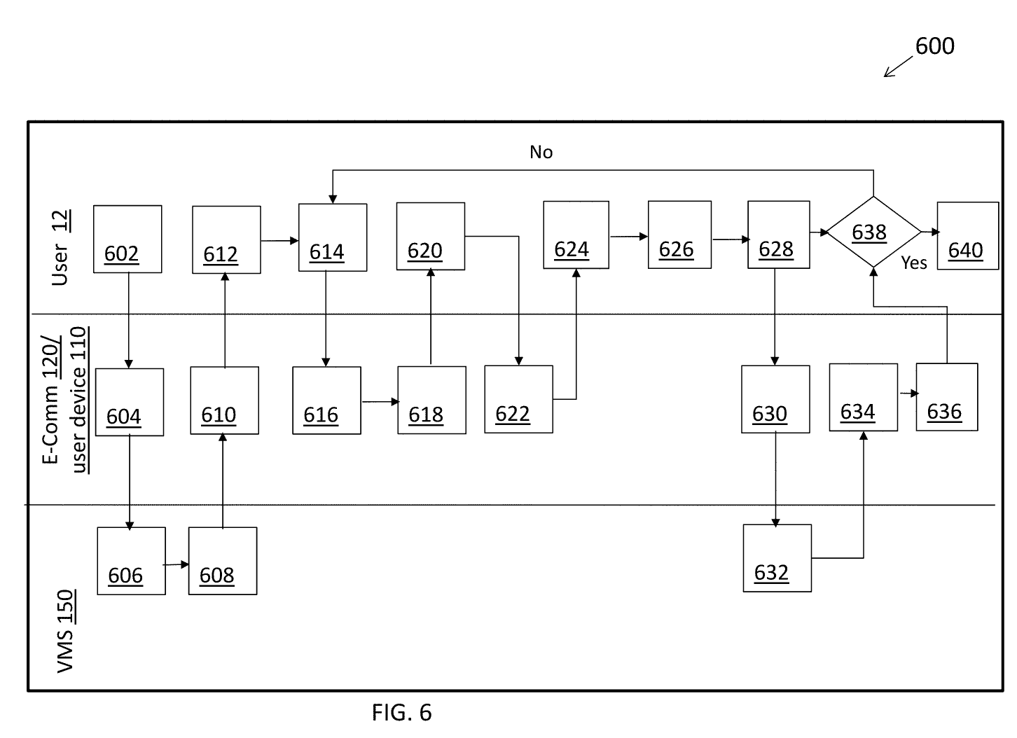

FIG. 6 is a flow diagram of a method 600 for in-store AR shopping, in accordance with some embodiments. Steps of the method 600 may be executable by the voucher management system 150 of FIGS. 1 and 2, and in-store electronic devices such as location detection technology 170 described in the environment illustrated in FIG. 1.

At block 602, the user 12 chooses one or more vouchers to shop with. Block 602 is similar to block 406 of method 400 described in FIG. 4, and therefore details are not repeated due to brevity.

At block 604, substantiation rules corresponding to the selected voucher(s) are retrieved by the voucher management system 150, for example, stored at the customer account database 135 or the voucher database.

At block 606, the voucher management system 150 searches for, finds, and validates the substantiation vouchers selected at block 602.

At block 608, the voucher management system 150 provides rules for each submitted substantiation voucher. Block 608 is similar to block 412 of method 400 described in FIG. 4, and therefore details are not repeated due to brevity.

At block 610, a determination is made what store the user 12 is in and what items are valid for the vouchers. In some embodiments, the user device 110 includes an AR application, for example, Google Glass, Microsoft Hololens, mobile phone etc., which may use location detection technology 170, for example, WiFi, global positioning system (GPS), geofence, and so on, and/or a camera or other features of the user device 110 to collect data regarding a location of the user 12, what items may be in view, or other data. The application may also use vouchers identified in the user's account, for example, online account stored at the account database 135.

At block 612, the user 12 may select to operate the AR application in an AR mode, in order to activate the location-based technology 170, or user device features such as a camera or the like to collect user and/or item data.

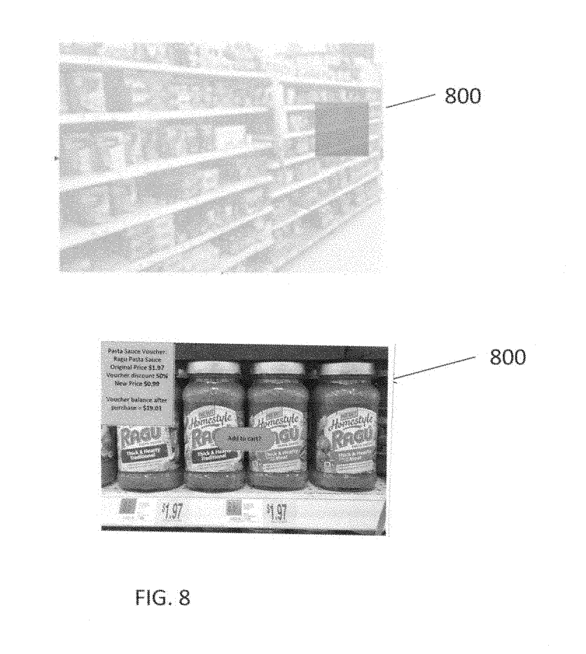

At block 614, the user 12 searches for an item or service valid in the store and tied to a voucher by pointing the camera or related sensor of the user device 110 at items of interest, for example, items located on shelves, for example, shown in FIG. 8. In FIG. 8, a smartphone camera captures an image of a store shelf at where a region 800 includes identified items permitted for purchase under a selected voucher.

At block 616, the user device 110 may use a combination of images collected by the device camera, GPS, or other location technology on the user device 110 and/or location information from the location detection technology 170 present at the store, or a combination thereof to determine a location of the user 12. The location of the user 12 may be important for matching a location of the user 12 with items in a predetermined region of the location of the user 12 to compare the identified items in the predetermined region with established rules to automatically recalculate a voucher balance, or to direct the user 12 to items of interest based on items permitted under the voucher restrictions, or other features. Along these lines, at block 618, the user device 110 may receive a display of visual cues for items that are valid for the selected voucher, for example, price, balance, and so on as shown in FIG. 8 At block 620, the user 12 performs an action such as approaches an item of interest or pauses for a predetermined amount of time at or near the item of interest. This action is detected by the user device 110, the location detection technology 170, and/or other sensors, and output to the voucher management system 150 which at block 622 triggers from this data a display of relevant information to the user device 110, for example, original price, discount, balance, and/or other item-related information based on any voucher restrictions identified for the item of interest.

At block 624, the user 12 decides to purchase the item of interest. At block 626, vouchers used to purchase the item can be edited.

At block 628, the user 12 item of interest may be added to a cart. A button may be selected to add the item to an online shopping cart, or the user 12 may select a button on the user device 110 indicating that the item has been added to a physical shopping cart.

Blocks 630-636, decision diamond 638, and block 640 are similar to block 524-530, decision diamond 532, and block 534, respectively, and are not repeated for brevity.

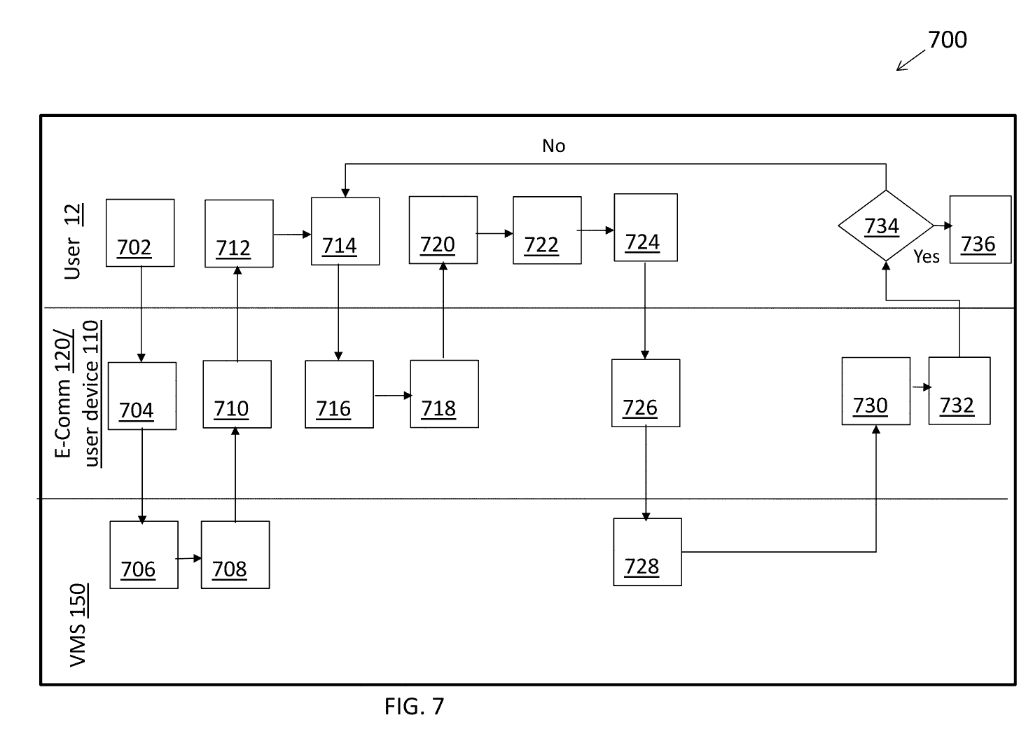

FIG. 7 is a flow diagram of a method 700 for in-store shopping with substantiation vouchers, in accordance with some embodiments. Steps of the method 700 may be executable by one or more of the computer elements described in the environment illustrated in FIG. 1.

At block 702, the user 12 chooses one or more vouchers to shop with. Block 702 is similar to block 406 of method 400 described in FIG. 4, and therefore details are not repeated due to brevity.

At block 704, substantiation rules corresponding to the selected voucher(s) are retrieved by the voucher management system 150, for example, stored at the customer account database 135 or the voucher database.

At block 706, the voucher management system 150 searches for, finds, and validates the substantiation vouchers selected at block 702.

At block 708, the voucher management system 150 provides rules for each submitted substantiation voucher. Block 708 is similar to block 412 of method 400 described in FIG. 4, and therefore details are not repeated due to brevity.

At block 710, a determination is made what store the user 12 is in and which items are valid for the vouchers used by the user 12, for example, using location-based devices in communication with the voucher management system 150.

At block 712, the user 12 may select whether to operate the mobile device 110 in a manual scan or lookup mode. The mobile device 110 may include a barcode scanner or the like for scanning an identifier on an item of interest.

At block 714, the user 12 searches for an item or service of interest in the store, and when an item of interest is found, scanning the store item, for example, scanning a barcode or QR code on the store item using the mobile device 110 or store-provided scanner.

At block 716, an item page is generated. For example, a shopper may be physically present at or near an item and can scan it with a scanning device to retrieve item information.

At block 718, a display of relevant information is displayed at the user device 110, for example, original price, discount, balance, and/or other item-related information based on any voucher restrictions identified for the item of interest.

At block 720, the user 12 decides to purchase the item of interest. At block 722, vouchers used to purchase the item can be edited. At block 724, the item of interest may be added to an electronic shopping cart.

Blocks 726-732, decision diamond 734, and block 736 are similar to block 524-530, decision diamond 532, and block 534, respectively of FIG. 5 and blocks 630-636, decision diamond 638, and block 640 of FIG. 6, respectively, so details thereof are not repeated for brevity.

As described herein, some or all of the systems and methods in accordance with some embodiments are implemented in a computer system. The computer system may generally comprise a processor, an input device coupled to the processor, an output device coupled to the processor, and memory devices coupled to the processor via a bus or other signal-carrying connector. The processor may perform computations and control the functions of a computer, including executing instructions included in computer code for the tools and programs capable of implementing a method in the manner prescribed by the embodiments of the figures using the system described with respect to the figures, wherein the instructions of the computer code may be executed by processor via memory device. The computer code may include software or program instructions that may implement one or more algorithms for implementing the systems and methods, as described in detail above. The processor may execute the computer code.

A memory device may include input data. The input data includes any inputs required by the computer code. The output device may display output from the computer code. The memory device may be used as a computer-usable storage medium (or program storage device) having a computer-readable program embodied therein and/or having other data stored therein, wherein the computer-readable program comprises the computer code. Generally, a computer program product (or, alternatively, an article of manufacture) of the computer system may comprise said computer-usable storage medium (or said program storage device).

Memory devices include any known computer-readable storage medium, including those described in detail below. In one embodiment, cache memory elements of memory devices may provide temporary storage of at least some program code in order to reduce the number of times code must be retrieved from bulk storage while instructions of the computer code are executed. Moreover, similar to processor, memory device may reside at a single physical location, including one or more types of data storage, or be distributed across a plurality of physical systems in various forms. Further, memory device can include data distributed across, for example, a local area network (LAN) or a wide area network (WAN). Further, memory device may include an operating system (not shown) and may include other systems not shown.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to embodiments of the present inventive concepts. Thus, an embodiment of the present invention discloses a process for supporting computer infrastructure, where the process includes providing at least one support service for at least one of integrating, hosting, maintaining and deploying computer-readable code in a computer system including one or more processor(s), wherein the processor(s) carry out instructions contained in the computer code causing the computer system to allow an employment and operation of embodiments of the present invention. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method according to embodiments herein. Thus, the present invention discloses a process for supporting, deploying and/or integrating computer infrastructure, integrating, hosting, maintaining, and deploying computer-readable code into the computer system, wherein the code in combination with the computer system is capable of performing a method according to some embodiments.

A computer program product of the present invention comprises one or more computer-readable hardware storage devices having computer-readable program code stored therein, said program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for processing a voucher, comprising:
receiving and processing data including a rule regarding use of a voucher;
generating a filtered result from the processed data according to the rule; and
modifying contents of an online location displayed on a computer display in response to the filtered result.

2. The method of claim 1, wherein the rule establishes store items permitted for purchase by the voucher or items prohibited from purchase by the voucher.

3. The method of claim 1, further comprising:
receiving a voucher identifier from the voucher;
retrieving, from a voucher database, voucher usage parameters associated with the voucher identifier;
receiving item identifiers for one or more items for purchase; and
generating the filtered result by determining whether each of the one or more items for purchase is redeemable by comparing the voucher usage parameters, the item identifiers, and the voucher use rule.

4. The method of claim 1, wherein modifying contents of the computer display includes presenting the contents in a filter mode, wherein the display of the content is controlled within a web site.

5. The method of claim 1, wherein modifying contents of the computer display includes presenting the contents at a different online location, and wherein the display of the content is controlled within a different online display location.

6. The method of claim 1, further comprising selecting the voucher from a plurality of vouchers displayed for selection.

7. The method of claim 1, wherein displaying the contents comprises modifying a website display to only specific items identified according to the substantiation rule.

8. The method of claim 1, wherein the voucher includes a form of at least one of a restricted shopping card, shopping card, gift card, reusable card, single use card or coupon that is physical or digitally presented for use, and includes at least one of a magnetic stripe, bar code, QR code, card number, or printed security pin to use for identification.

9. The method of claim 1, wherein the voucher is a substantiation voucher, wherein the voucher data of the substantiation voucher includes a record that identifies products for authorization or rejection.

10. The method of claim 1, wherein the voucher includes a form of a government benefits card (WIC/EBT), wherein the rule regarding use of the government benefits card includes a prohibited first set of predetermined products and services for purchase using the government benefits card, and wherein the filtered result includes a second set of items excluding the first set of items.

11. The method of claim 1, wherein the rule regarding use of the voucher is stored with customer account information at a remote data repository, and is accessed in response to use of the voucher.

12. The method of claim 1, further comprising:
automatically applying a modified price of the voucher data in response to the filtered result authorizing purchase of an item or service of the display output.

13. The method of claim 1, further comprising:
receiving from an augmented reality processor context data that includes real-time data;
applying the context data to the rule regarding use of the voucher; and
generating the filtered result from a combination of the context data and the processed data.

14. The method of claim 1, wherein the filter result is displayed to include store departments, item results in the departments, and web pages of the item, service, or department results.

15. A voucher management system, comprising:
an input for receiving data regarding a voucher;
a filter module for processing a use-based rule included in the voucher data, and generating a filtered result; and
a display modification module for modifying contents of an online location displayed on a computer display in response to the filtered result, including displaying items or services of interest identified by the filtered result.

16. The voucher management system of claim 15 further comprising a voucher rule processor that receives and processes data including usage parameter restrictions regarding voucher use.

17. The voucher management system of claim 15 further comprising a voucher tracking processor that collects status data regarding the voucher.

18. The voucher management system of claim 15 further comprising an augmented reality processor that receives and processes context data that includes location information regarding a user or item of interest, and applies the context data to the use-based rule, wherein the filter module generates the filtered result from a combination of the context data and the processed data.

19. The voucher management system of claim 15 further comprising a notification engine that generates a notification of a price change or an insufficient balance on the voucher.

20. A method of redeeming a purchase voucher comprising:
receiving a voucher identifier;
retrieving voucher usage parameters associated with the voucher identifier;
retrieving substantiation rules from the voucher usage parameters; and
displaying one or more items for purchase permitted by the substantiation rules.
